(19) United States
(12) Patent Application Publication
(10) Pub. No.: US 2017/0368841 A1
(43) Pub. Date: Dec. 28, 2017

(54) Method of Manufacturing a Functional Fabric

(71) Applicant: Fabricoat Industrial Corp., Nantou City (TW)

(72) Inventors: Hung-Jung Wang, Nantou City (TW); Szu-Kai Wang, Nantou City (TW)

(21) Appl. No.: 15/195,579

(22) Filed: Jun. 28, 2016

(51) Int. Cl. B41J 3/407; D06P 5/24; D06L 1/14; D06P 5/30; D06F 35/00

(52) U.S. Cl. CPC B41J 3/4078; D06P 5/30; D06F 35/00; D06L 1/14; D06P 5/003

(57) ABSTRACT

A method of manufacturing a functional fabric includes the steps of: (a) providing an undyed base fabric having a top surface and a bottom surface opposite to the top surface; (b) forming a moisture-permeable waterproof layer on the top surface of the base fabric; and (c) forming at least one pattern layer on at least one of the moisture-permeable waterproof layer or the bottom surface of the base fabric.

### FIELD

The disclosure relates to a method of manufacturing a functional fabric, more particularly to a method of manufacturing a functional fabric having a moisture-permeable waterproof layer.

### BACKGROUND

In general, fabric manufacturing includes pre-treatment, dyeing and finishing that is conducted to impart the required functional properties to the fabric.

Pre-treatment includes desizing, scouring, and bleaching a fabric. The purpose of the pre-treatment is to remove impurities of the basic fabric so as to facilitate subsequent processing of the fabric.

Dyeing is normally conducted in a solution containing dyes and particular chemical additives. The chemical additives may include an accelerating agent, a retarding agent, a leveling agent, and a fixing agent, etc., that accomplish superior dying effects.

Finishing refers to the processes that convert the fabric into a finished fabric to improve the look, performance, or feel of the fabric, or to impart the fabric with required functional properties such as being wrinkle resistant, water repellent, water proof, fire proof, and soil repellent. During the finishing processes, chemical agents, e.g., a water-repellent agent, are usually used.

However, most of the chemical additives and chemical agents have biological toxicities, and even contain carcinogenic heavy metals. As such, a significant amount of water is usually used in the fabric manufacturing processes to remove the chemical additives and the chemical agents. The waste water produced in the fabric manufacturing process poses harm to humans and the environment.

Furthermore, during the dyeing procedure, a dye in a solution may diffuse to an undesired region due to capillarity, and pattern distortion might occur.

### SUMMARY

Therefore, an object of the disclosure is to provide a method of manufacturing a functional fabric that can alleviate at least one of the drawbacks of the prior art.

According to the disclosure, the method of manufacturing a functional fabric includes the steps of:

(a) providing an undyed base fabric having a top surface and a bottom surface opposite to the top surface;

(b) forming a moisture-permeable waterproof layer on the top surface of the base fabric; and

(c) forming at least one pattern layer on at least one of the moisture-permeable waterproof layer or the bottom surface of the base fabric.

### BRIEF DESCRIPTION OF THE DRAWINGS

Other features and advantages of the disclosure will become apparent in the following detailed description of the embodiment with reference to the accompanying drawings, of which:

FIG. 1 is a flow chart illustrating the embodiment of a method of manufacturing a functional fabric according to the disclosure;

FIG. 2 is a sectional view illustrating the step (a) of the embodiment;

FIG. 3 is a sectional view illustrating the step (b) of the embodiment;

FIG. 4 is a sectional view illustrating the step (c) of the embodiment;

FIG. 5 is a sectional view illustrating a variation of the step (c) of the embodiment; and

FIG. 6 is a sectional view illustrating another variation of the step (c) of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

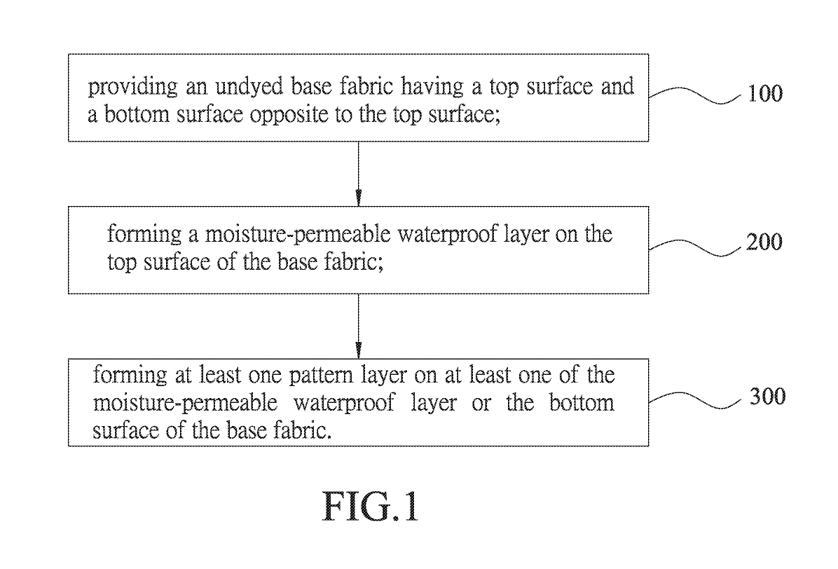

FIG. 1 illustrates the embodiment of a method of manufacturing a functional fabric according to the disclosure, which includes steps (a), (b), and (c).

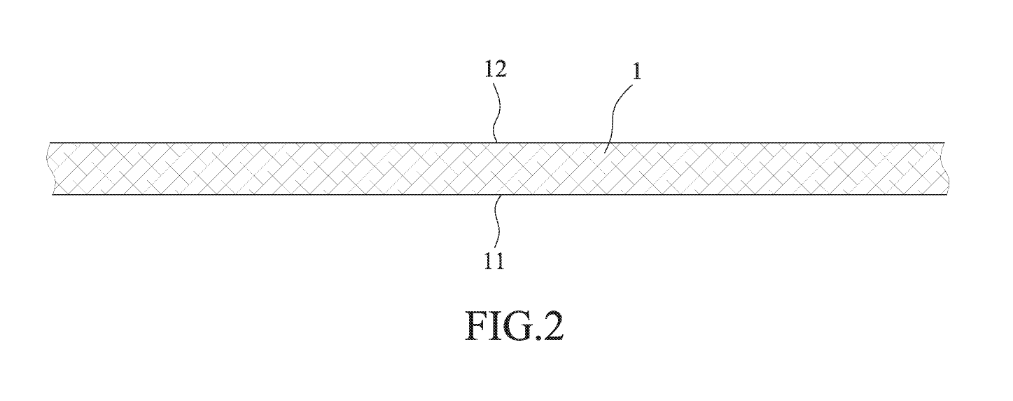

Referring to FIGS. 1 and 2, the step (a) includes providing an undyed base fabric 1 that has a top surface 12 and a bottom surface 11 opposite to the top surface 12.

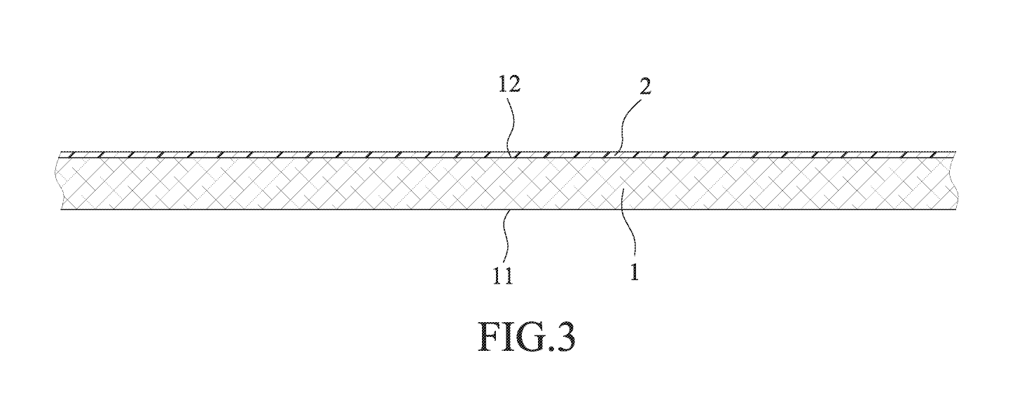

Referring to FIGS. 1 and 3, the step (b) includes forming a moisture-permeable waterproof layer 2 on the top surface 12 of the base fabric 1. The moisture-permeable waterproof layer 2 may be formed by dry coating a moisture-permeable waterproof resin on the top surface 12 of the base fabric 1 to form an even layer of the moisture-permeable waterproof resin, followed by drying the moisture-permeable waterproof resin to form the moisture-permeable waterproof layer.

In certain embodiments, the step (b) of forming the moisture-permeable waterproof layer 2 may be conducted by wet coating. Specifically, the step (b) is conducted by coating the moisture-permeable waterproof resin on the top surface 12 of the base fabric 1 to form an even layer of the moisture-permeable waterproof resin. After that, the base fabric 1 with the moisture-permeable waterproof resin is immersed in a water bath to remove a solvent contained in the moisture-permeable waterproof resin. Finally, the layer of the moisture-permeable waterproof resin and the base fabric 1 are heated and dried to form the moisture-permeable waterproof layer 2 on the undyed base fabric 1.

In certain embodiments, the step (b) may be conducted by applying an even layer of the moisture-permeable waterproof resin on a release film (not shown), attaching the layer of the moisture-permeable waterproof resin onto the top surface 12 of the base fabric 1, removing the release film from the layer of the moisture-permeable waterproof resin, and drying the layer of the moisture-permeable waterproof resin to form the moisture-permeable waterproof layer 2 on the undyed base fabric 1.

In certain embodiments, the moisture-permeable waterproof layer 2 is a commercially available product and may be directly adhered onto the top surface 12 of the base fabric 1.

It should be noted that, the moisture-permeable waterproof layer 2 may be made from a material, e.g., polyurethane, polyethylene (PE), polytetrafluoroethene (PTFE), or polymethylmethacrylate (PMMA, also called acrylic). In certain embodiments, the moisture-permeable waterproof layer 2 is made from thermoplastic polyurethane (TPU). In certain embodiments, the moisture-permeable waterproof layer 2 may further exhibit windproof properties.

In certain embodiments, the moisture-permeable waterproof layer 2 may further include a pigment.

In this disclosure, before step (b), the base fabric 1 is not subjected to any treatment for imparting functional properties to the base fabric.

Referring to FIGS. 1 and 4 to 6, the step (c) includes forming at least one pattern layer 3 on at least one of the moisture-permeable waterproof layer 2 or the bottom surface 11 of the base fabric 1. The functional fabric thus obtained includes the base fabric 1, the moisture-permeable waterproof layer 2, and the at least one pattern layer 3.

In certain embodiments, before the step (a), the method further includes the step (d) of pre-treating the base fabric 1 to remove impurities and wrinkles of the base fabric 1 so as to facilitate adhesion of the moisture-permeable waterproof layer 2 and the pattern layer 3 on the base fabric 1, thereby improving the appearance and texture of the functional fabric thus obtained. In certain embodiments, the step (d) includes desizing, scouring, and bleaching the base fabric 1.

In certain embodiments, the step (c) of forming at least one pattern layer 3 may be conducted by inkjet printing, roller printing, screen printing, decal transferring, or thermal transferring. In certain embodiments, the step (c) may be conducted by flocking.

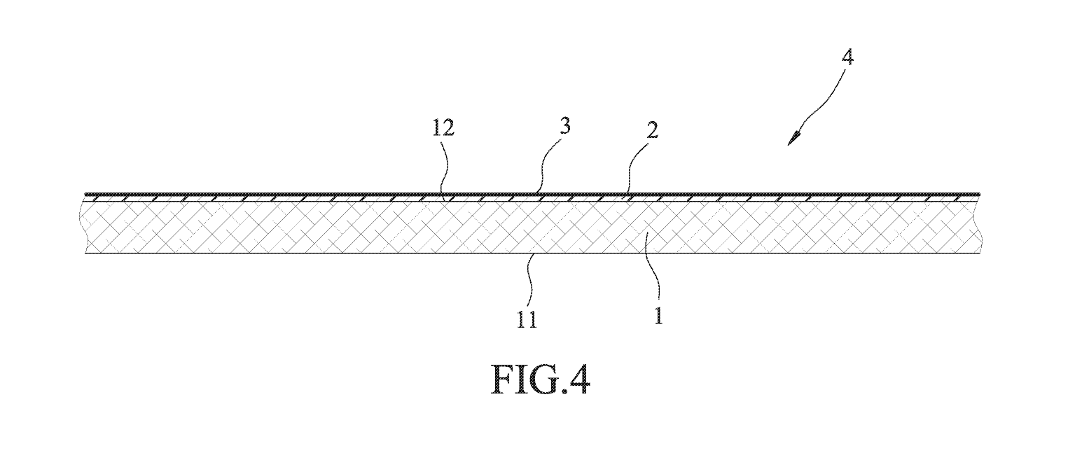

In certain embodiments, the pattern layer 3 is formed on the moisture-permeable waterproof layer 2 (as shown in FIG. 4).

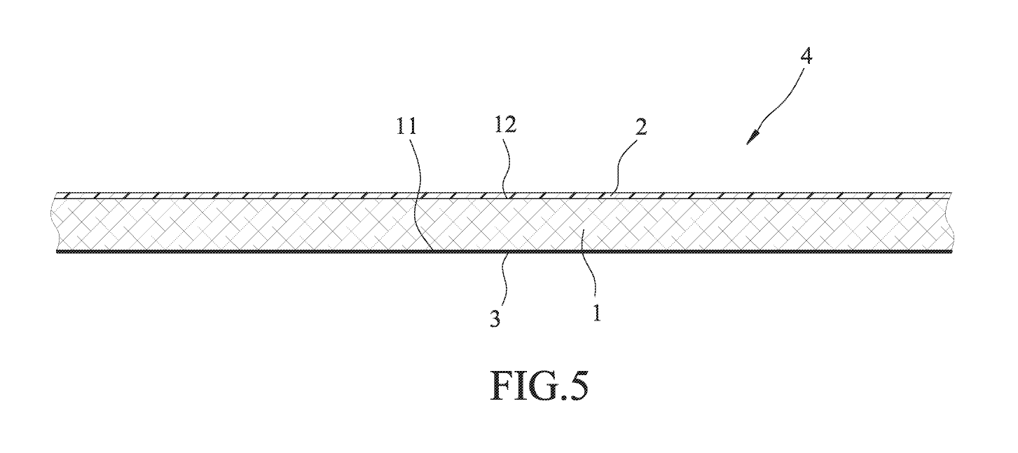

In certain embodiments, the pattern layer 3 is formed on the bottom surface 11 of the undyed base fabric 1 (as shown in FIG. 5).

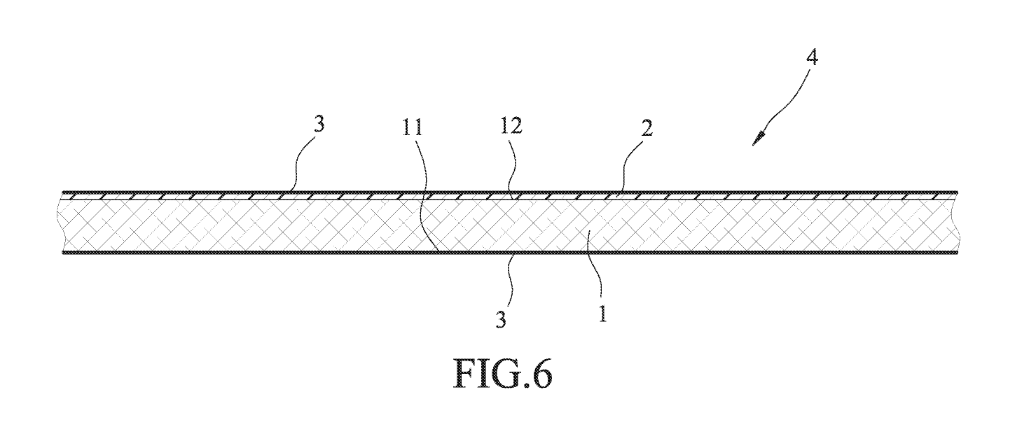

In certain embodiments, the functional fabric has two of the pattern layers 3 which are respectively formed on the moisture-permeable waterproof layer 2 and the bottom surface 11 of the undyed base fabric 1 (as shown in FIG. 6).

In certain embodiments, the pattern layers 3 further have a two-dimensional or three-dimensional texture.

In certain embodiments, the pattern layer 3 may exhibit warming, cooling, or anti-bacterial functions, to name a few, depending on the material thereof.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of manufacturing a functional fabric, comprising the steps of:
(a) providing an undyed base fabric having a top surface and a bottom surface opposite to the top surface;
(b) forming a moisture-permeable waterproof layer on the top surface of the base fabric; and
(c) forming at least one pattern layer on at least one of the moisture-permeable waterproof layer or the bottom surface of the base fabric.

2. The method of claim 1, further comprising, before the step (a), the step (d) of pre-treating the base fabric to remove impurities of the base fabric.

3. The method of claim 2, wherein the step (d) includes desizing, scouring, and bleaching the base fabric.

4. The method of claim 1, wherein the step (b) of forming the moisture-permeable waterproof layer is conducted by dry coating.

5. The method of claim 1, wherein the step (b) of forming the moisture-permeable waterproof layer is conducted by wet coating.

6. The method of claim 1, wherein the step (b) of forming the moisture-permeable waterproof layer is conducted by applying a layer of a moisture-permeable waterproof resin on a release film, attaching the layer of the moisture-permeable waterproof resin onto the top surface of the base fabric, removing the release film from the layer of the moisture-permeable waterproof resin, and drying the layer of the moisture-permeable waterproof resin.

7. The method of claim 1, wherein the step (b) of forming the moisture-permeable waterproof layer is conducted by directly adhering the moisture-permeable waterproof layer onto the top surface of the base fabric.

8. The method of claim 1, wherein the step (c) of forming at least one pattern layer is conducted by a process selected from the group consisting of inkjet printing, roller printing, screen printing, decal transferring, thermal transferring, and flocking.

9. The method of claim 4, wherein the step (c) of forming at least one pattern layer is conducted by a process selected from the group consisting of inkjet printing, roller printing, screen printing, decal transferring, thermal transferring, and flocking.

10. The method of claim 5, wherein the step (c) of forming at least one pattern layer is conducted by a process selected from the group consisting of inkjet printing, roller printing, screen printing, decal transferring, thermal transferring, and flocking.

11. The method of claim 6, wherein the step (c) of forming at least one pattern layer is conducted by a process selected from the group consisting of inkjet printing, roller printing, screen printing, decal transferring, thermal transferring, and flocking.

12. The method of claim 7, wherein the step (c) of forming at least one pattern layer is conducted by a process selected from the group consisting of inkjet printing, roller printing, screen printing, decal transferring, thermal transferring, and flocking.

13. The method of claim 1, wherein the pattern layer has one of anti-bacterial, warming, and cooling functions.

14. The method of claim 1, wherein the moisture-permeable waterproof layer is made from a material selected from the group consisting of polyurethane, polyethylene, polytetrafluoroethene, and polymethylmethacrylate.

15. The method of claim 14, wherein the moisture-permeable waterproof layer is made from thermoplastic polyurethane.

16. The method of claim 1, wherein the moisture-permeable waterproof layer further includes a pigment.

17. The method of claim 1, wherein, before step (b), the base fabric is not subjected to any treatment for imparting functional properties to the base fabric.
